(19) United States
(12) Patent Application Publication
(10) Pub. No.: US 2006/0149645 A1
(43) Pub. Date: Jul. 6, 2006

(54) Non-capitalization weighted stock market index and index fund or funds

(76) Inventor: Paul Christoper Wood, Coral Gables, FL (US)

Correspondence Address: VENABLE LLP, P.O. BOX 34385, WASHINGTON, DC, 20045-9998, US

(21) Appl. No.: 10/159,610

(22) Filed: Jun. 3, 2002

(51) Int. Cl. G06Q 40/00

(52) U.S. Cl. 705/35

(57) ABSTRACT

A method for the construction of a new type of stock market index, and stock market index fund, or funds where the index is constructed based upon the fundamental realities of the companies contained within the index rather than on the price, or market capitalization of the companies contained with the index. This fundamental data may include items such as the relative size of a collection of company's profits or assets or any fundamental accounting data contained within a standard U.S. GAAP company annual report and accounts.

### BACKGROUND OF THE INVENTION

Most commonly used stock market indices are constructed using a methodology that is based upon either the relative share prices of a sample of companies (such as the Dow Jones Industrial Average) or the relative market capitalization of a sample of companies (such as the S&P 500 Index). The nature of the construction of both of these types of indices means that if the price or the market capitalization of one company rises relative to its peers in the index, it is accorded a larger weighting in the index. Alternatively, a company whose share price or market capitalization declines relative to the other companies in the index is accorded a smaller index weighting. This can create a situation where the index, index funds, or investors who desire their funds to closely track an index, are compelled to have a higher weighting in companies whose share prices or market capitalizations have already risen and a lower weighting in companies that have seen a decline in their share price or market capitalization. These price or market capitalization based indices can contribute to a “herding” behavior on the behalf of investors by effectively compelling any of the funds that attempt to follow these indices to have a larger weighting in shares as their price goes up and a lower weighting in shares that have declined in price. This may create unnecessary volatility, which is not in the interests of most investors. It may also lead to investment returns that have had to absorb the phenomenon of having to repeatedly increase weightings in shares after they have risen and reduce weightings in them after they have fallen.

### SUMMARY

The invention described below describes a method for the creation of a new class of stock market indices and index funds. This new class of stock market indices may base its weightings on the fundamentals of the companies that make up that index.

### DETAILED DESCRIPTION OF THE INVENTION

In an exemplary embodiment of the present invention, a new series of fundamental stock market indices in which the index weightings are determined by company fundamentals may help to address some of the issues raised above. Company fundamentals may include such factors as, for example: the relative size of a company's profits; its pre-exceptional profits; sales; return on investment; or any fundamental accounting item, and/or ratio. An index that determines its weightings based on company fundamentals, rather than the share price or market capitalization, may have a stabilizing element within it that can help reduce the excess volatility that can be generated by indices that are constructed on the basis of price or market capitalization alone. Over the medium to longer term, such fundamentally based indices have the potential to outperform price or market capitalization-based indices, and to do so with less volatility.

In an exemplary embodiment, a fundamentally based stock market index may be based on the relative size of a sample of the indexed companies' pre-exceptional profits. If the exemplary index is chosen to include one hundred companies, and the fundamental criteria that to be used is ‘largest pre-exceptional profits’, then the exemplary index would contain the one hundred largest companies as defined by the size of their pre-exceptional profits. To further illustrate the example, if the total pre-exceptional profits of the largest one hundred companies, as measured by their pre-exceptional profits, was $100 billion in a defined time period (such as a quarter or a year) and in the same time period the pre-exceptional profits of theoretical company A were $ 2 billion then theoretical company A would be allocated a 2% weighting in the fundamental index. If theoretical company B had pre-exceptional profits of $1.5 billion in the same time period, company B would have a weighting of 1.5% in the index. Index weightings are managed based on how the fundamentals of the companies within, or outside, the chosen index sample change. As an example, the index manager could choose to rebalance the weightings either quarterly, as company pre-exceptional profits change, or on an annual basis. If, for instance, by the time of the next rebalancing period the total pre-exceptional profits of the largest one hundred companies, as measured by their pre-exceptional profits, had grown to $120 bn, and theoretical company A now had pre-exceptional profits of $1.2 billion, its weighting in the index would be down to 1% from 2% in the previous period. An advantage of a fundamental index according to embodiments of the present invention is that such an index may give an investor the opportunity to follow, or invest, passively in an index which is anchored to the economic realities of the companies within it.

A fundamental stock market index may be created by using any of the fundamental data points regarding a company or a group of companies that can be found in a regular U.S. generally accepted accounting principles (GAAP) company annual report and accounts. As one example, an index of companies may be created based on the relative size of one or more of the companies' sales, assets, profits, cash flow and/or the shareholders' equity. In addition, the fundamental index may also be created by using a ratio of any of the data concerning a company or group of companies that is contained in a standard U.S. GAAP company report and accounts. For example, such ratios may include the relative size of the return on assets of a selection of companies, their return on investment, or their return on capital compared to their cost of capital.

Once the index manager has decided which fundamental criteria to use, and how many constituents the manager decides that he or she wants to include in the index, the index can be created in the following way. If, as in the above example, the index manager decides to construct a fundamental stock market index of one hundred constituent members and s to use pre-exceptional profit as the chosen fundamental criteria, the index can be made as follows. First, the index construction manager may perform a search to find which are the largest one hundred listed companies as defined by the size of their pre-exceptional profits. Once the manager has determined the largest one hundred listed companies for the chosen criterion, he or she may construct the index. If the combined pre-exceptional profits of the one hundred companies are $100 billion and theoretical company A has pre-exceptional profits of $2 billion then company A would have an index weighting of 2%. Companies would be accorded index weightings based on the relative size of their pre-exceptional profits.

Once the one hundred companies in the index have been accorded their weightings, the index performance may be calculated going forward as the share prices of the different companies in the index change from day to day. This can be achieved, for example, by assuming a starting value for the index, or index portfolio, and then calculating how each of the index constituents performs going forward.

The index manager may then choose to rebalance the index weightings as the fundamental data points change over time. For instance, if at the end of the next company reporting season the combined pre-exceptional profits of the one hundred largest companies grows from $100 billion to $120 billion and the pre-exceptional profits of theoretical company A decline from $2 billion to $1.2 billion, company A's weighting in the index would decline from 2% in the prior period to 1% in the current period. Also, some of the original companies in the first one hundred may be eliminated from the index if their pre-exceptional profits fall below a certain level while new companies that were not in the original sample could be included. The index manager could choose to rebalance the weightings in the index either as individual companies report their pre-exceptional profits on a quarterly basis, or he or she could wait until the majority of companies had reported their pre-exceptional profits and then adjust them all at once. Also, the manager may choose to determine the weightings based on either the total nominal amount of pre-exceptional profit each quarter or on a cumulative rolling basis. Constructing a stock market index using fundamental company accounts data or a ratio, or manipulation of that data may provide a series of genuine alternatives for investors who want to invest in a passive style while focusing on fundamentals that they believe are important. For instance, an investor may always want to own an index of U.S. or foreign equities that are the largest five hundred companies as measured by sales, or by profits, or by growth in sales, or by return on investment, or any fundamental company accounts data or ratio of that data.

1. A method for the construction and management of a stock market index and stock market index funds containing a portfolio of stocks based on this index, wherein the stock market index is based on fundamental company data, the method comprising:
creating a stock market index, and at least one stock market index funds including a portfolio of stocks where the constituent weightings are based upon at least one fundamental accounting data regarding the companies whose stocks are included in the portfolio.

2. The method of claim 1, further comprising basing the constituent weightings upon at least one of a ratio and/or a manipulation of the fundamental accounting data.

3. The method of claim 1, wherein constituent weightings of the stocks within the fund are altered as the fundamental data concerning the companies in or outside the index changes.

4. The method of claim 3, wherein the constituent weightings of the stocks within the fund are altered when at least one of: a company or companies report their quarterly and/or annual accounting information; and/or at a pre-determined time after which the majority of companies in the index have reported their quarterly and/or annual accounting data.

5. The method of claim 1, wherein the fundamental accounting data includes data can be found within a standard U.S. generally accepted accounting principles (GAAP) company annual report and accounts.

6. The method of claim 1, wherein the fundamental accounting data includes at least one of: relative size of a company's profits, a company's pre-exceptional profits, sales, assets, cash flow, shareholders' equity, and/or a return on investment.

7. The method of claim 1, wherein the fundamental accounting data comprise:
a weighted combination of sales, profits, cash flow, and another fundamental data point from a GAAP.

8. The method of claim 7, wherein the another fundamental data point comprises dividends.
